(19) United States
(12) Patent Application Publication
(10) Pub. No.: US 2019/0017652 A1
(43) Pub. Date: Jan. 17, 2019

(54) MODULAR AND EASILY REMOVABLE MOUNTING APPARATUS FOR BIRD HOUSE AND BIRD FEEDER

(71) Applicants: Akram Hossain, Munster, IN (US); Vivek Pillarisetty, Hammond (US)

(72) Inventors: Akram Hossain, Munster, IN (US); Vivek Pillarisetty, Hammond (US)

(21) Appl. No.: 15/647,801

(22) Filed: Jul. 12, 2017

(51) Int. Cl. F16M 13/02; A01K 39/01; E04H 12/22

(52) U.S. Cl. CPC F16M 13/02; A01K 31/14; E04H 12/2253; A01K 39/0113

(57) ABSTRACT

This invention of mounting apparatus has quick release, enhanced stability against high wind velocity, extended life cycle, and ground animal tamper proof for birdhouse and bird feeder. This design of inner plate mechanism provides higher contact area and distributes pressure on the mounting pipe that allows all the above advantages. These set of mounting apparatus allows for different angular orientation, vertical position, and can also be used for other applications.

### BACKGROUND OF INVENTION

This invention of mounting apparatus for bird house and bird feeders is a novel design. In general a bird house or a bird feeder is located at a height from the ground so as to protect these things from tampered by animals like raccoons or squirrels. This positioning of the bird house at a height is done by holding the bird house on to a pipe and mounting the pipe to a wooden post. There are also some ways of positioning the bird house on to the side of the house.

The mountings that are currently available are difficult to remove for periodical cleaning. Apart from this, the holding point or the point where we tighten the pole will reduce the lifetime and may damage the pole. In order to remove, adjust or rotate the bird house in the desired height and direction it is difficult to do in the available mounting methods. Periodical cleaning of the birdhouse and replenishment of bird food are also difficult to do by the currently available methods. In addition to this frequent removal and adjustments will reduce the life cycle and effect the reusability of the pipe and also the mounting material. This proposed design will help in easier removal and adjustment of the bird house and bird feeders. The use of concentric cylindrical design helps in having an inner plate that pushes or applies pressure on to the mounting pipe to hold at a particular position. This design of inner plate mechanism will apply the pressure on to the mounting pipe equally and increase the contact area so that the pipe is held firmly and will withstand to most of the natural forces such as breeze and occasional higher velocity winds. The proposed set of mounting apparatus is equipped with the similar inner plate mechanism and thus usable in different applications.

### SUMMARY

This invention is intended to provide higher strength, ease of use, increased reusability of the mounting pipe and the apparatus. The use of inner plate design favors in having stability to the entire assembly. The mounting will have a bolt and nut mechanism to push the inner plate towards the pipe and this is possible by welding the inner plate to the end of the bolt. The nut is place between the head of the bolt and the outer circular clamp. A chamfer is made to house the nut on the outer circular clamp. Whenever the nut is rotated circularly it is pushed towards the outer clamp that translates the circular motion to linear and pushes the mounting pipe toward the wooden post or the other end of the clamping apparatus. This allows enhanced strength and will allow the bird house to withstand to conditions such as gales and high wind velocities. These set of mounting apparatus follow the same mechanism and will provide the same advantages while used individually or as a set. The claimed set of mounting apparatus are used for mounting and bird house and bird feeder. These mounting apparatus allows to mount bird house and bird feeder at any desired orientation.

### LIST OF FIGURES

FIG. 1: Perspective View

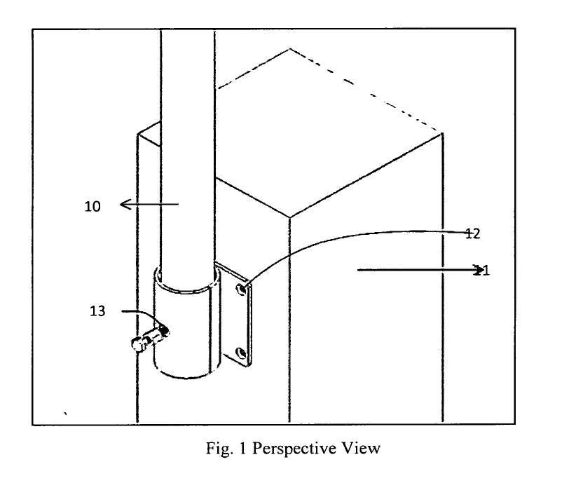

FIG. 2: Top View of Mounting Apparatus Design 1

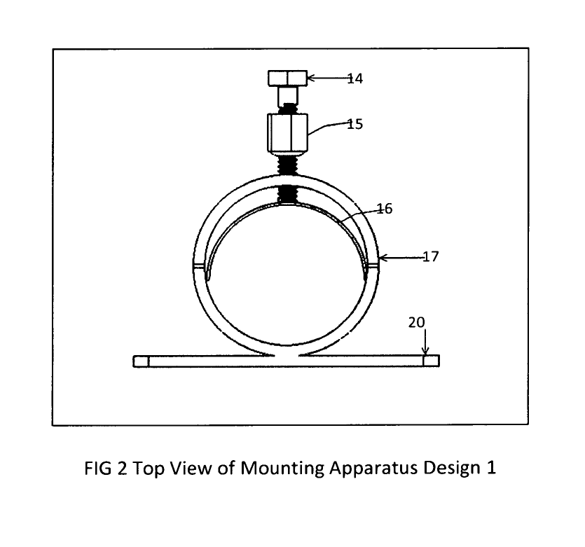

FIG. 3: Inner Plate and Bolt Welded Together

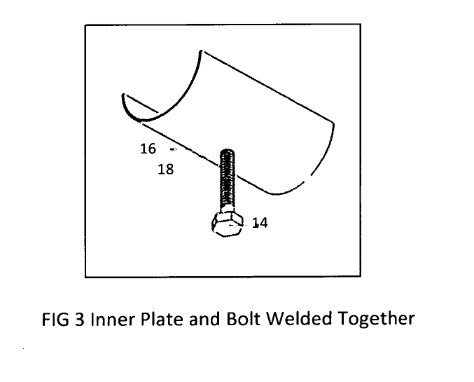

FIG. 4: Top View of Mounting Apparatus Design 2

FIG. 5: Perspective View of Mounting Apparatus of Design 2

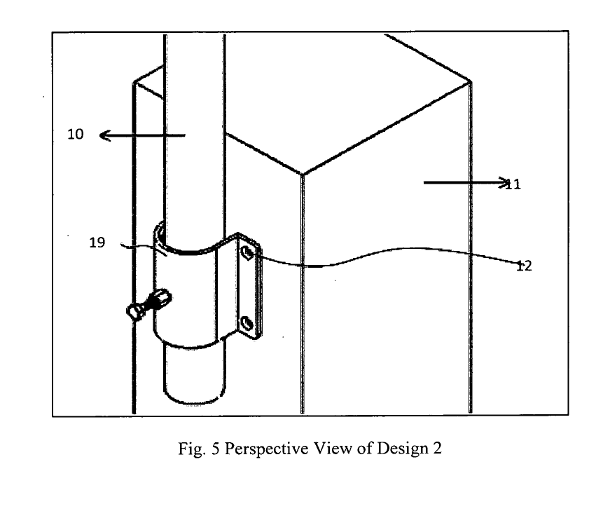

FIG. 6: Under mount Design

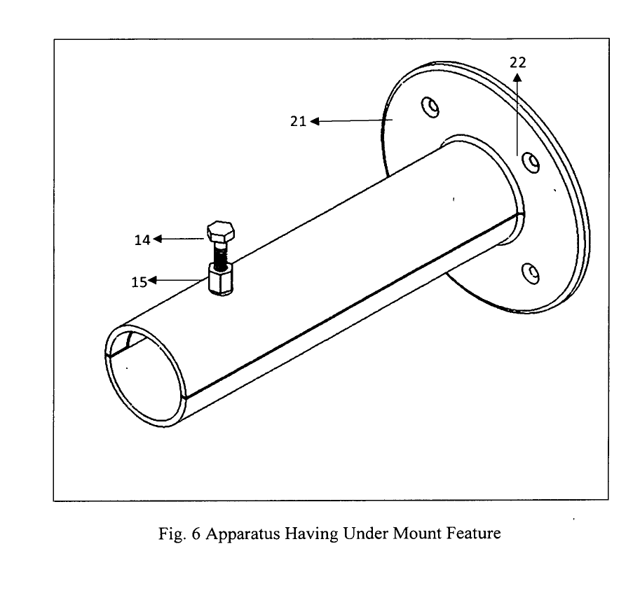

FIG. 7: Application 1

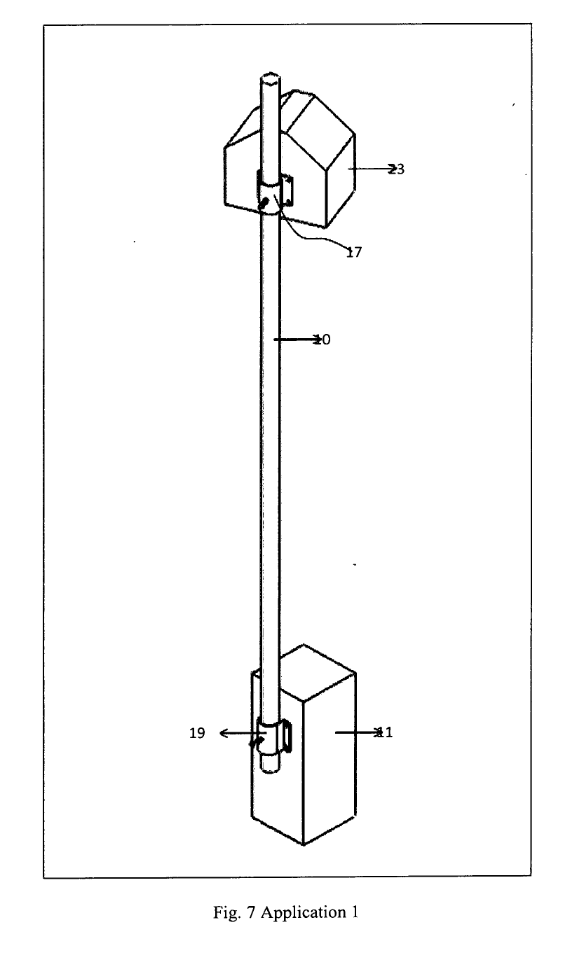

FIG. 8: Application 2

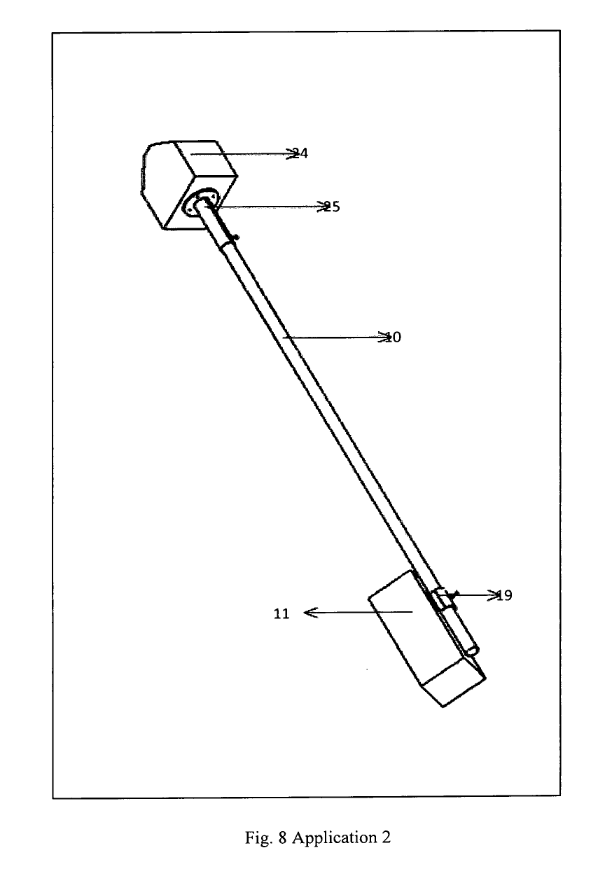

FIG. 9: Application 3

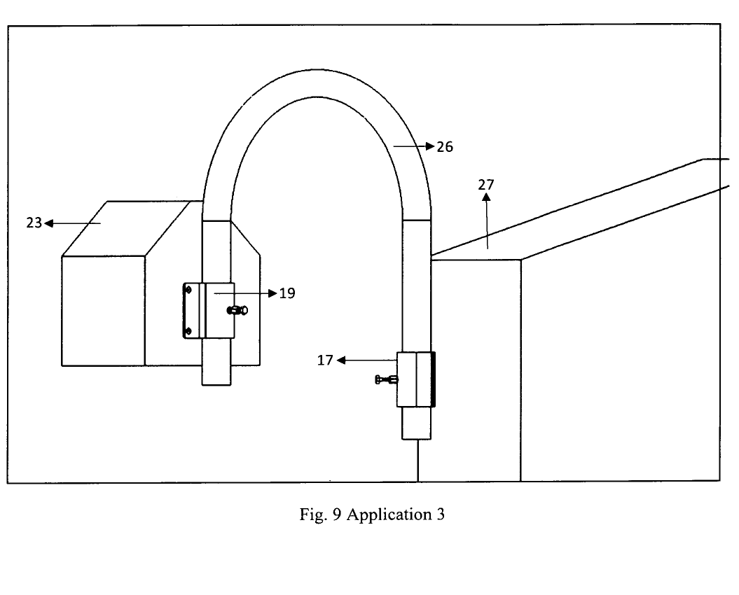

### TABLE OF PARTS AND PART NUMBERS

10—Mounting pipe (Pole)
11—Wooden Post
12—Holes for the mounting screw
13—Counter sink holes
14—Bolt
15—Nuts
16—Inner plate
17—Circular outer tubular member Design 1
18—Welded point on the inner plate
19—Outer clamp Design 2
20—Rectangular outer plate
21—Circular Plate to mount bird house
22—Screw holes to mount the apparatus below
23—Bird House
24—Bird Feeder
25—Apparatus Having Under Mount Feature
26—Bend pipe
27—House

### DETAILED DESCRIPTION

The claimed apparatus has a circular outer tubular member 17 which is welded to rectangular outer plate 20 that houses the mounting pipe 10. This rectangular outer plate 20 has four counter sink holes for mounting 12 the apparatus on a wooden post 11 or bird house 23 and bird feeder 24. The mounting pipe 10 that allows height adjustment to the mounted bird house 10 or bird feeder 11 is placed inside the circular outer tubular member 17. The inner plate 16 holds the mounting pipe 10 on a desired height and direction. The inner plate 16 is welded to the bolt 14 that allows for linear motion of the inner plate 16. The linear motion of inner plate 16 and bolt 14 is possible due to 360 degree rotation of the nut 15. Counter sink hole 13 on the circular outer tubular member 17 restricts the nut 15 and translates the rotational force to linear that makes the inner plate 16 to move toward the mounting pipe 10. The inner plate 16 applies equal pressure there by provides enhanced stability to the mounting pipe 10 that holds mounted bird house 23 or bird feeder 24. This design of inner plate 16 increases the life cycle of the mounting pipe 10 as contact surface is larger than the conventional method of mounting.

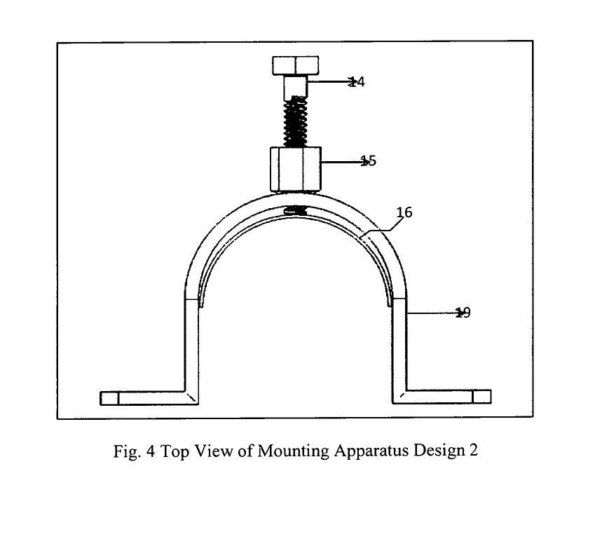

Similarly we have created two more different models of mounting apparatus FIG. 4 is the top view of the model. This model has an outer clamp 19 with four counter sink holes 12 to mount the whole apparatus to a wooden post 11 or to the side of a House 27. The operation of the inner plate 16 and design is similar to the model with a circular outer tubular member 17. But in this model the mounting pipes 10 is pushed towards the surface of the wooden post 10 or the Bird House 23 that it is mounted to. This design of inner plate 16 and nut-bolt 14, 15 arrangements are common to all the proposed models that can be used to remove bird house 23 or bird feeder 24 to clean and to refill easily. In addition to a pair of nut-bolt 15, 14 it could have two or three pairs coupled with larger inner plate 16 that increases surface area and in turn provides enhanced stability to the mounting apparatus.

The claimed apparatus could be made of any of the following three material choices: Aluminum, Stainless Steel, Galvanized Steel

1. This is a set of mounting apparatus for both Bird house and Bird feeders.

2. The apparatus of claim 1 is capable of mounting both bird house and bird feeder vertically on a pole and side mounted on walls.

3. The claimed apparatus has an inner plate to hold the pole on which the bird house or the bird feeder is mounted that is capable of higher load capacities and can withstand higher wind velocities.

4. The apparatus of claim 3 comprises of mountings that are easily removable, adjustable and provides enhanced stability to the mounting apparatus.

5. Inner plate assembly in claim 3 allows increased contact area between the pole and the mounting apparatus. This feature prevents applying pressure at a single point.

6. The apparatus of claim 5, will increase the life cycle of the pole as well as the apparatus.

7. This claimed apparatus can be attached at the bottom or on the side of a bird house or a feeder.

8. The apparatus in claim 7 is used to mount the bird house or bird feeder on a wooden post, pole or to the side of the house.

9. Since the apparatus in claim 1 accommodates several different standard sizes of pipes, both PVC as well as galvanized metals. This allows placement of bird house and feeders at a considerable height and a significant load.

10. As the apparatus of claim 3 has an inner plate that allows a 360° rotation of the bird house or the feeder without change in height.

11. The apparatus of claim 4 allows easy access to bird feeder and bird house for periodic replenishment of bird food and cleaning.

12. The apparatus of claim 9 can accommodate different sizes and different height of mounting pipes. This feature naturally provide ground animal (such as raccoon and squirrel) tamper free arrangement for bird house and bird feeder.
